(19) United States
(12) Patent Application Publication
(10) Pub. No.: US 2010/0137004 A1
(43) Pub. Date: Jun. 3, 2010

(54) LOCATION AND AVAILABILITY DRIVEN (LAD) SERVICES PLATFORM FOR WIRELESS TERMINAL DEVICES

(75) Inventors: Ofir Ron, Tel Aviv (IL); Nadav Bar-Or, Tel Aviv (IL)

Correspondence Address: MERCHANT & GOULD PC, P.O. BOX 2903, MINNEAPOLIS, MN, 55402-0903, US

(73) Assignee: CELLAPP INC., Wilmington (DE)

(21) Appl. No.: 12/523,493

(22) PCT Filed: Jan. 24, 2008
(86) PCT No.: PCT/IL2008/000112

§ 371 Date: Feb. 2, 2010

(30) Foreign Application Priority Data
Jan. 25, 2007 (IL) 180952

(51) Int. Cl. H04W 64/00

(52) U.S. Cl. 455/456.3

(57) ABSTRACT

Method and system for performing electronic commerce over a data network via a local application of a user's wireless device and a LAD engine. Accordingly, the user registers to the system for the wireless device and downloads the local application into the wireless device. Then the user activates the local application and provides an address upon request from the local application. The local application provides the user with a menu of available items/services which are relevant to the address and the user selects entries on the menu, for reaching sub-levels of the menu that include lists specific merchants and selects a specific merchant and desired items/services provided by this specific merchant. The user submits an order of the desired items/services by the local application to the system, which stores the order in a database and relays the order from the system to the merchant by the server. The user is billed and the merchant fills an order, for supplying the desired items/services to the address.

### FIELD OF THE INVENTION

The present invention relates to the field of electronic commerce. Specifically, this invention relates to a system for providing Location and Availability Driven (LAD) services via an application installed on a wireless device.

### BACKGROUND OF THE INVENTION

During recent years, the capabilities of wireless devices, such as cellular phones, Personal Digital Assistants (PDAs), etc., have been substantially increased. One of the main advances in the field is that of wireless electronic commerce. There are web sites which offer various services, including services related to fast food, supermarkets, photo development, etc. Many existing wireless devices allow access to such web sites, thereby providing their user with many electronic commerce capabilities.

However, the access to those services is some times inconvenient, and can also be time consuming. Mostly, a user who wishes to access a specific service performs a search using any suitable search engine, e.g., Google, and is provided thereby with a relatively long list of web sites relating to the search topics. The user must then enter into each site, until reaching one that satisfies his needs. As well known, such manual sifting through the different sites may become very tedious. Furthermore, it is time consuming, and since in most wireless devices the user is charged for the time connected to the internet, it turns out to be expensive, as well.

In order to improve the services provided to wireless device users, several methods and systems have been developed for simplifying the process of performing electronic commerce. WO 01/13298, for example, discloses a method and system for facilitating the purchase of goods or services via wireless devices. According to this method, the user is provided with a menu that lists various types of goods and services, from which the user selects a specific item. Once the item is selected, the system transmits the request to the relevant merchant who fills the order on demand. However, this system does not optimize services according to location and availability data.

None of the systems and methods disclosed in the prior art provide solutions for all of the disadvantages related to electronic commerce. For example, many search engines and menus described in the prior art lack information. In addition, the prior art methods mostly provide no means for the merchants to update information regarding their goods/services. This can be problematic, since the user may be provided with misleading and incorrect information. Furthermore, many of the menus described in the prior art provide worldwide information, while users are generally interested in local goods/services provided in specific areas and available in specific times. This disadvantage causes the user to again need to sift through enormous amounts of irrelevant data, which is not required.

Also, many of the prior art methods disclose systems which are operable only while maintaining a connection to the internet throughout the entire process. Therefore, even though implementing such methods saves some time in relation to performing a general search on the internet, they are still more costly than methods which provide services that are mainly conducted offline.

It would therefore be highly desirable to develop a method that is able to provide an updated menu containing only information about services that are relevant to a specific user, his location and the availability of these services.

It would also be desirable to develop a method wherein most of the process is performed offline. Implementing such a method would be not only convenient, but also cost effective.

It is an object of the present invention to provide a method for conducting wireless electronic commerce, including receiving information and purchasing items/services from different merchants, that provides the user with relevant, up-to-date, information regarding the requested items/services.

It is a further object of the present invention to provide a method by which part of the wireless commerce activities are conducted in an offline manner, using local features and applications stored in the wireless device.

Further purposes and advantages of this invention will become apparent as the description proceeds.

### SUMMARY OF THE INVENTION

The present invention is directed to a method for performing electronic commerce over a data network via a local application of a user's wireless device and a LAD engine. Accordingly, the user registers to the system manually or automatically for the wireless device and downloads the local application from the system into the wireless device. Then the user activates the local application on the wireless device and provides an address upon request from the local application. The local application provides the user with a menu of available items/services being relevant to the address and the user selects entries on the menu, for reaching sub-levels of the menu. The user reaches a sub-level which lists specific merchants and selects a specific merchant and desired items/services provided by the specific merchant. The user submits an order of the desired items/services by the local application to the system, which stores the order in a database on the system and relays the order from the system to the merchant by the server of the system. The user is billed via cash upon delivery, a check a credit card or a cellular phone bill and the merchant fills an order, for supplying the desired items/services to the address.

The local application may implement a technology such as J2ME, BREW, Wireless Application Protocol (WAP: a specification for a set of communication protocols to standardize the way that wireless devices, such as cellular telephones) interface or any other client interface.

Predefined addresses or a default address may be entered into the local application, installed on the wireless device. The location of the user may be automatically provided by a location determination system, such as a Global Positioning System (GPS) or a cellular-based location determination system.

After the user selects desired items/services, he may place his order directly to the merchant, rather than via the system.

Each merchant can update the information on the system relating to his services, and the updates are automatically directed from the system to the local application on each registered user's wireless device. Each merchant may receive a unique password for allowing him to enter the system and to independently update any information found therein relating to his services. Each merchant may enter the geographical areas covered by his services and his business hours. Each merchant may select his service covered areas or sub-areas from displayed city maps which are divided to sub-zones or from sub-zones he determines.

The local application may include a list of items/services according to data entered by the merchant regarding geographical areas covered by his services and his business hours. The menu of available items/services may be being relevant also to the time of request.

The local application preferably stores data related to the most recent orders/searches and may comprise a “favorites” list in which the user can save any desired entries. Advertisement may be displayed to the user by the system, for allowing the user to select from an item from a menu that is associated with the displayed advertisement.

The present invention is also directed to a system for performing electronic commerce over a data network via a local application of a user's wireless device and a Location and Availability Driven (LAD) system, that comprises:
a) a local application, installed on the wireless device;
b) a server with a server application for analyzing the incoming requests from the local application, communicating between all the components of the system and for submitting requests for services;
c) a database server, for storing retrieving and updating data relevant to requests;
d) a web GUI interface for updating the menus of providers into the data base one or more manager applications for creating and updating menus and their associated content and for monitoring orders; and
e) a common web interface for:
providing information services;
downloading the application to the user's mobile device;
providing registration services into the system.

All the above and other characteristics and advantages of the invention will be further understood through the following illustrative and non-limitative description of preferred embodiments thereof.

### BRIEF DESCRIPTION OF DRAWINGS

The above and other characteristics and advantages of the invention will be better understood through the following illustrative and non-limitative detailed description of preferred embodiments thereof, with reference to the appended drawings, wherein:

FIG. 1 is a flow chart describing the method proposed by the present invention; and

FIG. 2 schematically illustrates a system for providing LAD services via an application installed on a wireless device, according to a preferred embodiment of the invention.

### DETAILED DESCRIPTION OF PREFERRED EMBODIMENTS

In view of the drawbacks of the prior art methods, there is a need for an improved method for conducting wireless electronic commerce.

Consequently, the present invention discloses a method for conducting LAD wireless electronic commerce, which overcomes the disadvantages of prior art.

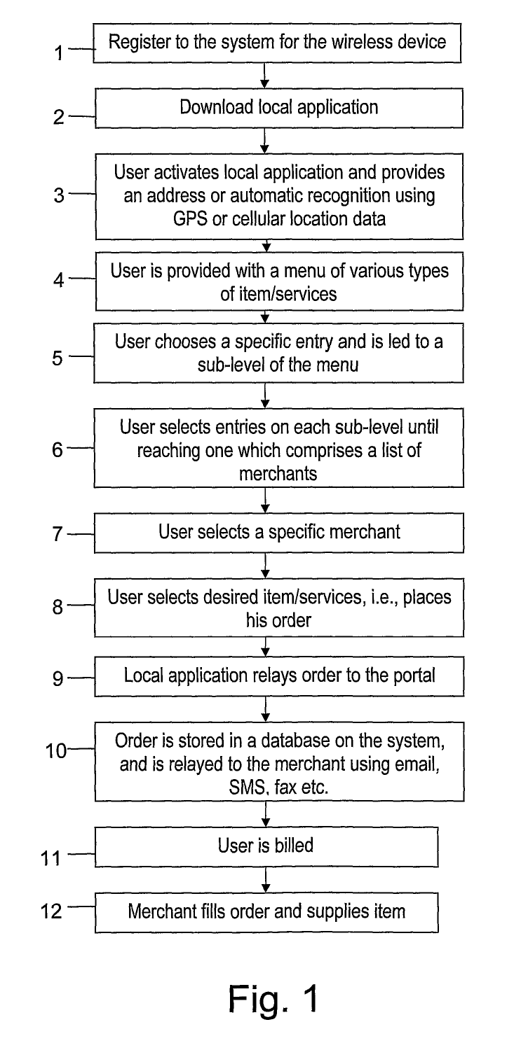

FIG. 1 is a flow chart describing the method proposed by the present invention. According to the method of the present invention, the user of a wireless device, (e.g., a cellular phone or a PDA), registers to the service via a dedicated web interface (step 1). The user is then provided with a local application which is downloaded into his wireless device (step 2), In another embodiment of the present invention, the downloading process comprises the registry within it, thus, once the local application is downloaded and an automatic registration process begins. The user is registered to the service after completing the registration process. Once registration is done, the user is logging in the service automatically, each time he activates the application. Optionally, the user's personal information can be obtained automatically from his wireless device, and transmitted by the local application to the system.

The local application implemented according to the present invention can be of any appropriate technology. For example, in cellular phones that support JAVA™, used mainly in GSM (global system for mobile communications) networks, the local application can be of J2ME technology (Java 2 Platform, Micro Edition is a technology that allows programmers to use the Java programming language and related tools to develop programs for mobile wireless devices). In cellular phones belonging to CDMA (Code Division Multiple Access) networks, the BREW (Binary Runtime Environment for Wireless) technology can be used for the local application.

The local application residing on the wireless device provides the user with a menu relating to various types of items/services offered by various merchants, which can be purchased online. The method of the present invention relates mainly to merchants who deliver their items/services to required locations, e.g., the user's home/work address. Since the method of the present invention is related to delivered items/services, upon any access of the user to the local application, he is initially required to provide the address to which he is interested that the item/service be delivered (step 3). According to an embodiment of the present invention, predefined addresses may be entered into the local application, and the user must provide a new address only if he is interested in a service at a different location. According to the present invention, the local application comprises world-wide data that is loaded and updated according to the wireless device's location, and can thus be used in any geographical location.

Once the local application receives the relevant address it provides the user with a menu relating to all items/services provided by merchants registered to the platform, which their services are available at time of request and who are willing to deliver their merchandise to the relevant address (step 4) or who wish to inform the user about services located in his geographical area. The LAD engine receives the relevant items/services, maps and analyzes the covered areas and the availability of the service providers and implements an advanced mechanism which searches, filters and returns quick results to the user.

The user then chooses an item of interest on the menu, and receives a detailed list of all items/services under that entry (step 5). For example, the main menu can contain a “fast food” entry. Choosing that will lead the user to a more detailed list comprising, for example, “pizza”, “hamburgers”, “pasta” etc. Choosing any of the sub-entries leads the user to a detailed list of all relevant merchants providing the requested item/service (step 6). It should be understood that the present invention relates to any type of items/services, such as, restaurants, photo development, electrician, plumbers, theater or sporting events, ticket offices, etc.

The user then selects any merchant he desires, and receives all relevant information related to that merchant and to his products/services (step 7). For example, if a restaurant has been selected, the user preferably receives detailed menus, including prices, specialty dishes, etc.

All of the above operations, except for registering to the system and downloading the local application, can be performed offline on the user's wireless device while saving time and charges for connection.

In the next stage, the user selects the items/services he wishes to receive (step 8), and then the system switches to an online mode. The user's request is transmitted by the local application to the server (step 9). The server saves the order in a database, and sends a copy thereof to the selected merchant by any appropriate means, e.g., by fax email, or SMS, as configured by the merchant (step 10). The user may be billed in any appropriate way, e.g., in cash with receipt of item/service, via a credit card, a check, or through the cellular phone bill, (step 11). Finally, the merchant fills the order, and delivers the items/services to the appropriate address (step 12).

In another embodiment of the present invention, the local application provides the user with a LAD calling service directory, including phone numbers of the merchants, which enables him to directly call the merchant and to thereby place an order by a regular phone conversation.

As would be understood by those familiar with the art, the user may search the information in the local application to find any data of interest, within the vicinity of any specific geographical location, without submitting an order. Since the local application resides on the user's wireless device, such a search is free of internet connection charges.

According to the present invention, the merchants registered to the system are able to update the information regarding their services. These updates will take effect as soon as the service data is asked for by the user's application (i.e., the next time the user is entering the merchant's menu). In a specific embodiment of the present invention the merchants are obliged to update their data on the platform if any changes occur, thereby ensuring that the data found on the local applications is always up-to-date.

In an embodiment of the present invention, the merchant is required to enter the geographical areas covered by his services and his business hours. This data is used by the LAD engine when a request is received by the system.

In another embodiment of the present invention, each merchant receives a unique password which allows him to connect to the system. Once the merchant enters the system he can change/add/delete any data related to his own services, such as, prices, products, offered services, etc. The merchant can update the database using any relevant application, preferably a web application.

In a preferred embodiment of the present invention, the local application stores the details of the most recent order/searches. Therefore, if the user wishes to repeat the same search/order, he just selects it from the list found on the local application.

In yet another embodiment of the present invention the local application comprises a “favorites” list, in which the user can save any entries that he is likely to be interested in again, in the future.

According to another embodiment of present invention, the any data update in the system which is relevant to the location of the wireless device is automatically loaded into local memory of the wireless device for later use. This way, the wireless device continuously aggregates a collection of phone numbers of LAD services in that location and its surrounding area, up to a predetermined limit.

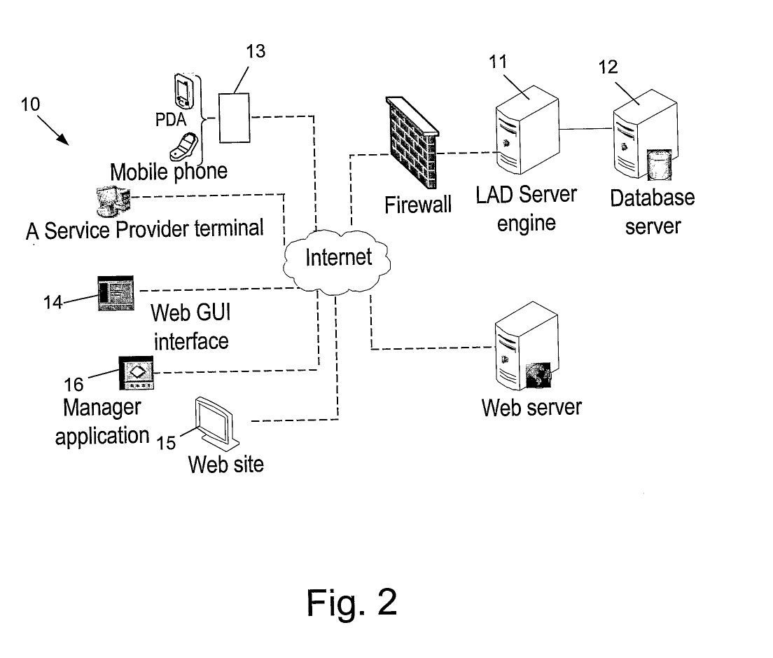

FIG. 2 schematically illustrates a system for providing LAD services via an application installed on a wireless device, according to a preferred embodiment of the invention. The proposed system 10 includes a LAD engine server 11, a DB server 12, the local application 13, the web GUI interface 14, the website 15 and a manager application 16.

The local application 13 is installed on the operation system platform of the wireless device of the user. Once the application is installed, it can be activated by selecting it in Applications category of the wireless device.

The server application communicates between all the components of the system. Once the LAD engine server 11 is activated, it starts receiving requests from the local applications 13. The server 11 exchanges data with the DB 12, in order to retrieve and update the relevant data according to the received requests. The server 11 is also responsible for sending the orders to the merchants by first recognizing the method of sending requests to the destination and then sends the order by using that method directly to the merchant's ordering system.

The data base 12 stores the complete data of the system, such as customers' details, restaurants menus, the restaurants covered delivery zones, the restaurants business hours etc. The data base is being updated by the server 11.

The web GUI interface 14 updates the merchants' menus into the data base 12. Each merchant gets a unique password which allows him to securely login into the system. Once the merchant connects to the system, he can create a new menu, adding and deleting categories and items, updating prices, etc. In addition, it provides information regarding the orders that have been submitted by the customers and regarding incoming calls received through the system.

The website 15 performs the following tasks:
Providing general information and explanations regarding the service;
Downloading the application to the user's mobile device;
Providing registration service, while the user is fully guided how to input his details.

Alternatively, after downloading the application, the user can input his details directly to the local application, instead of using the website 15 for this purpose.

The manager application 16 allows the system manager to monitor the activities of the system 10. The system manager can view the orders of each merchant, to produce reports, to block and allow the activity of a specific merchant, to send messages to the merchant etc.

According to a further embodiment of present invention, an advertisement banner can be displayed to the user by the system, in parallel to the menu of a specific service of interest. In this case, the user can select the banner and submit an order from a menu that is associated with the displayed banner, rather than using the current menu. The banner can also include an advertisement which is not related to any service provided by the application (in this case the banner cannot be selected by the user).

Although embodiments of the invention have been described by way of illustration, it will be understood that the invention may be carried out with many variations, modifications, and adaptations, without departing from its spirit or exceeding the scope, of the claims.

1. A method for performing electronic commerce over a data network via a local application of a user's wireless device and a Location and Availability Driven (LAD) system, comprising:
a. user registering to said system for said wireless device;
b. user downloading said local application from said system into said wireless device;
c. user activating said local application on said wireless device;
d. upon request from said local application, user providing a selected address, to which items/services should be provided;
e. providing the user, by said local application, with a menu that comprises only items/services that are determined, by said LAD system, as:
e.1) available at the time said address is provided by said user;
e.2) being relevant to said address;
f. user selecting entries on said menu, for reaching sub-levels of the menu;
g. user reaching a sub-level which lists specific merchants;
h. user selecting a specific merchant;
i. user selecting desired items/services provided by said specific merchant;
j. user submitting an order of said desired items/services by said local application to said system;
k. storing said order in a database on said system and relaying said order from said system to said merchant by the server of said system;
l. billing said user; and
m. filling of order by said merchant, for supplying the desired items/services to said address.

2. The method of claim 1, wherein the local application is of a technology selected from:
a. J2ME;
b. BREW;
c. WAP interface; or
d. Any other client interface.

3. The method according to claim 1, wherein predefined addresses are entered into the local application, installed on the wireless device.

4. The method according to claim 1, wherein a default address is entered into the local application.

5. The method according to claim 1 wherein the location of the user is automatically provided by a location determination system.

6. The method according to claim 1 wherein the location determination system is a GPS or cellular-based.

7. The method according to claim 1 wherein the user is billed via cash upon delivery; check, credit card; or cellular phone bill.

8. The method according to claim 1 wherein after the user selects desired items/services, said user places his order directly to the merchant, rather than via the system.

9. The method according to claim 1 wherein each merchant updates the information on the system relating to his services, and the updates are automatically directed from said system to the local application on each registered user's wireless device.

10. The method according to claim 9 wherein each merchant receives a unique password for allowing him to enter the system and to independently update any information found therein relating to his services.

11. The method according to claim 9, wherein each merchant enters the geographical areas covered by his services.

12. The method according to claim 9, wherein each merchant enters his business hours.

13. The method according to claim 11, wherein each merchant selects his service covered areas from a variety of displayed city maps.

14. The method according to claim 13 wherein each merchant selects his service covered sub-areas from displayed city maps which are divided to sub-zones or from sub-zones he determines on said displayed city maps.

15. The method according to claim 1, wherein the local application is provided with a list of items/services according to data entered by the merchant regarding geographical areas covered by his services and his business hours.

16. The method according to claim 1, wherein the menu of available items/services are being'relevant also to the time of request;

17. The method according to claim 1 wherein the local application stores data related to the most recent orders/searches.

18. The method according to claim 1 wherein the local application comprises a “favorites” list in which the user can save any desired entries.

19. The method according to claim 1, wherein registration is carried out manually or automatically.

20. The method according to claim 1, further comprising displaying advertisement to the user by the system, for allowing said user to select from an item from a menu that is associated with the displayed advertisement.

21. System for performing electronic commerce over a data network via a local application of a user's wireless device and a Location and Availability Driven (LAD) system, comprising:
a) a local application, installed on said wireless device;
b) a server with a server application for:
b.1) analyzing the incoming requests from said local application, for items/services to be provided to a selected address;
b.2) determining which items/services are available at the time said requests are submitted;
b.3) determining which items/services being available are relevant to said selected address;
b.4) communicating between all the components of said system and for submitting requests for services;
c) a database server, for storing retrieving and updating data relevant to requests;
d) a web GUI interface for updating the menus of providers into said data base one or more manager applications for creating and updating menus and their associated content and for monitoring orders; and
e) a common web interface for:
providing information services;
downloading the application to the user's mobile device;
providing registration services into said system.
